(19) United States
(12) Patent Application Publication
(10) Pub. No.: US 2017/0065929 A1
(43) Pub. Date: Mar. 9, 2017

(54) HYDROGEN SULFIDE SCRUBBER SYSTEMS AND METHODS

(71) Applicants: Charles Michael Stewart, Throckmorton, TX (US); Michael Jess Stewart, Stephenville, TX (US)

(72) Inventors: Charles Michael Stewart, Throckmorton, TX (US); Michael Jess Stewart, Stephenville, TX (US)

(21) Appl. No.: 14/701,491

(22) Filed: Apr. 30, 2015

Related U.S. Application Data
(60) Provisional application No. 61/986,853, filed on Apr. 30, 2014.

(51) Int. Cl. B01D 53/14

(52) U.S. Cl. CPC B01D 53/1468; B01D 2252/2021

(57) ABSTRACT

A hydrogen sulfide scrubbing is disclosed. An example system can include a natural gas inlet coupled to a pressure nozzle opening into a chamber having one or more baffles and a port configured to receive a scrubbing solution. The system can also include a coiled tubing member having an inlet coupled to an outlet of the chamber, the coiled tubing member having an outlet for discharging scrubbed natural gas.

This application claims the benefit of U.S. Provisional Application No. 61/986,853, entitled “HYDROGEN SULFIDE SCRUBBER SYSTEMS AND METHODS” and filed on Apr. 30, 2014, which is incorporated herein by reference in its entirety.

Embodiments relate generally to natural gas scrubber systems, and, more particularly, to systems and methods for scrubbing hydrogen sulfide (H2S) from natural gas.

Removal of hydrogen sulfide (e.g., “scrubbing”) from natural gas containing H2S (e.g. “sour” natural gas) may be becoming increasingly important due to an increased need for greater natural gas production. There are likely many wells both in the U.S. as well as in other countries that have been closed or are not producing because a level of H2S in their gas streams makes using or obtaining the natural gas uneconomical.

Hydrogen sulfide (H2S) is a highly corrosive gas, which can cause corrosion and damage to pipelines, tubing, pumps, engines and other equipment. The corrosion and damage from H2S can often make the prospect of operating a natural gas well with high levels of H2S to be breakeven at best.

Systems may exist to remove (or scrub) H2S from natural gas streams on a large scale. Also, there may be system to remove H2S on a smaller scale. Some of these existing systems may use relatively large quantities of scrubbing material or media such as fluids or dry material. Thus, there may be a need for an economical H2S scrubbing system for wells with sour natural gas that does not consume as much scrubbing medium as existing systems. In particular, an economical solution may be needed for smaller wells and/or wells with low flow rates.

Embodiments were conceived in light of the above-mentioned needs, problems and/or limitations, among other things.

Some implementations can include a hydrogen sulfide scrubbing system comprising a natural gas inlet coupled to a pressure nozzle opening into a chamber having one or more baffles and a port configured to receive a scrubbing solution. The system can also include a coiled tubing member having an inlet coupled to an outlet of the chamber, the coiled tubing member having an outlet for discharging scrubbed natural gas.

Some implementations can include a hydrogen sulfide scrubbing method comprising providing a scrubbing solution to a port of a scrubbing system chamber. The method can also include providing natural gas to an inlet coupled to a pressure nozzle opening into the chamber having one or more baffles and the port configured to receive the scrubbing solution. The method can further include moving the natural gas through the chamber via pressure and moving the natural gas through a coiled tubing member having an inlet coupled to an outlet of the chamber, the coiled tubing member having an outlet for discharging scrubbed natural gas. The method can also include removing scrubbed natural gas from the outlet of the coiled tubing member.

### BRIEF DESCRIPTION OF THE DRAWINGS

FIG. 1 is a perspective view of an example H2S scrubbing system in accordance with at least one embodiment.

### DETAILED DESCRIPTION

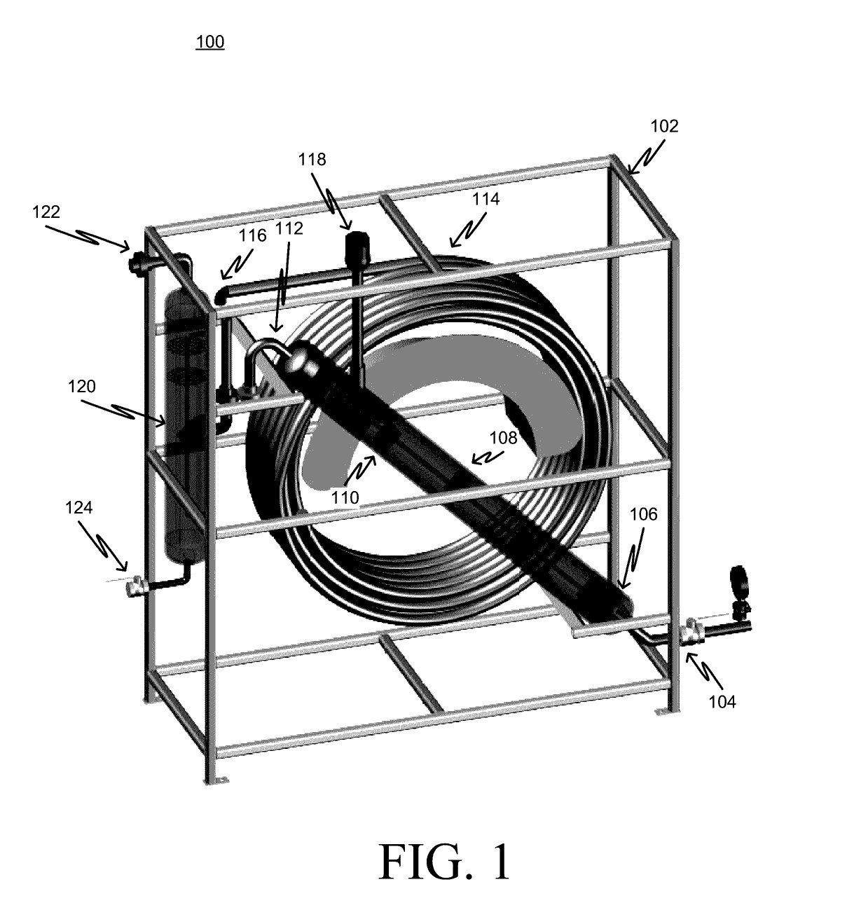

FIG. 1 shows an example H2S scrubbing system 100 in accordance with at least one embodiment. The system 100 includes a frame 102. It will be appreciated that the system 100 could be enclosed in a solid wall enclosure (not shown) or the like.

The system 100 also includes a chamber inlet port 104, a pressure nozzle 106, a chamber 108, one or more baffles 110, and a chamber outlet 112. The system 100 further includes a coiled tubing member 114 having an inlet (not shown) coupled to the chamber outlet 112 and a coiled tubing member outlet 116. The system also includes a scrubbing solution input port 118. The coiled tubing member outlet 116 is coupled to an optional discharge chamber 120 having a scrubbed gas outlet 122 and a waste removal port 124.

In operation, material to be scrubbed (e.g., sour natural gas containing H2S) is provided to the scrubbing system via chamber inlet port 104. The natural gas passes through a pressure nozzle 106 and then through chamber 108 containing one or more baffles 110. The baffles serve to help mix the natural gas with an H2S scrubbing solution (e.g., a methanol solution such as Spartan-12TC Hydrogen Sulfide Scavenger solution made by Spartan Chemicals of Fort Worth, Tex.) that has been supplied via the scrubbing solution port 118. In some implementations, the chamber 108 can be about 5 inches in diameter. It will be appreciated that the dimensions may vary depending on a contemplated implementation.

After passing through the chamber 108, the natural gas exits via the chamber outlet 112 and enter the inlet of the coiled tubing member 114. The coiled tubing member servers to “spin” the gas through multiple passes in scrubbing solution collected in the bottom portion of one or more of the individual coils of the coiled tubing member 114. Some implementations of the coiled tubing member 114 can include about 500 feet of size 1″ tubing arranged in coils having substantially the same or similar diameter. It will be appreciated that other configurations of the coiled tubing member 114 could be used.

The natural gas then exits the coiled tubing member 114 via the coiled tubing member outlet 116. The natural gas then enters an optional discharge chamber 120 (e.g., a chamber about 5 inches in diameter, but can vary depending on implementation) and exits via the scrubbed gas outlet 122. Waste (e.g., used scrubbing solution) can be removed from the system via the waste removal port 124.

It is, therefore, apparent that there is provided, in accordance with the various embodiments disclosed herein, systems and methods for scrubbing H2S from natural gas or from other substances in which H2S may be present.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A hydrogen sulfide scrubbing system comprising:
a natural gas inlet coupled to a pressure nozzle opening into a chamber having one or more baffles and a port configured to receive a scrubbing solution; and
a coiled tubing member having an inlet coupled to an outlet of the chamber, the coiled tubing member having an outlet for discharging scrubbed natural gas.

2. A hydrogen sulfide scrubbing method comprising:
providing a scrubbing solution to a port of a scrubbing system chamber;
providing natural gas to an inlet coupled to a pressure nozzle opening into the chamber having one or more baffles and the port configured to receive the scrubbing solution;
moving the natural gas through the chamber via pressure;
moving the natural gas through a coiled tubing member having an inlet coupled to an outlet of the chamber, the coiled tubing member having an outlet for discharging scrubbed natural gas; and
removing scrubbed natural gas from the outlet of the coiled tubing member.
